(19) United States
(12) Patent Application Publication
(10) Pub. No.: US 2019/0158367 A1
(43) Pub. Date: May 23, 2019

(54) SELECTION OF CLOUD SERVICE PROVIDERS TO HOST APPLICATIONS

(71) Applicant: HEWLETT PACKARD ENTERPRISE DEVELOPMENT LP, Houston, TX (US)

(72) Inventor: Vedanta BAROOAH, Bothell, WA (US)

(73) Assignee: HEWLETT PACKARD ENTERPRISE DEVELOPMENT LP, Houston, TX (US)

(21) Appl. No.: 15/820,259

(22) Filed: Nov. 21, 2017

(51) Int. Cl. H04L 12/24

(52) U.S. Cl. CPC H04L 41/5096; H04L 67/10

(57) ABSTRACT

According to examples, an apparatus may include a processor and a memory on which are stored machine readable instructions. The instructions may cause the processor to identify, based on a comparison of details of an application and details of the cloud applications hosted on a plurality of cloud service providers, which of the plurality of cloud service providers hosts a cloud application that matches the application, determine, for the cloud service providers that host the matching cloud applications, features associated with hosting the cloud applications and based on the determined features of the cloud service providers, and select a cloud service provider from the cloud service providers that host the matching cloud applications to host the application.

### BACKGROUND

Cloud computing provides users access to computing resources and data storage through a network, such as the Internet. The computing resources and data storage are typically provided to users via hardware equipment in data centers that are linked together over the network to form a “cloud.” The hardware equipment, such as servers, data storage devices, routers, switches, etc., are typically linked together through high-speed communications and management software guides the collective actions of the hardware equipment. Additionally, cloud service providers (CSPs) often charge fees to users to host and manage access to the computing resources and data storage.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may determine a recommended cloud service provider to host an application;

FIG. 2 shows a block diagram of an example environment including an apparatus that may select a CSP to host an application;

FIG. 3 shows a block diagram of an example environment including an apparatus that may select one or more of the CSPs to host entities of an evaluation group;

FIGS. 4A and 4B, respectively, depict flow diagrams of example methods of identifying one or more CSPs that may host an evaluation group; and

FIG. 5 is an example listing of the parameters pertaining to the various entities in the evaluation group.

### DETAILED DESCRIPTION

As computing models like “cloud” emerge, it may become increasingly difficult to employ conventional placement systems to map existing workloads or evaluation groups that may include servers, applications and services from traditional and virtual environments to equivalent services in targeted cloud destinations. Common approaches that take into account compute and application performance may suffice for Infrastructure as a Service (IaaS) deployment models. These approaches may not, however, support optimally placing applications into other deployment models like Software as a Service (SaaS) and Platform as a Service (PaaS) provided by industry standard cloud platforms. SaaS and PaaS platforms provide services beyond just compute capacity on top of traditional IaaS cloud infrastructures, which may be combined to create applications. This may pose a challenge in moving and running traditional applications on newer cloud platforms in an optimal way that uses the features of the cloud platform to full capacity. Moreover, considering just the compute and performance comparisons for CSP evaluations may lead to incorrect compute sizing in a target cloud platform. Traditional approaches of mapping the services required and provided by an application to similar services provided by the cloud platform may be a time-consuming, laborious task as multiple applications may be analyzed and mapped, which is typically the case in large scale enterprise data migrations. The problem may further be exacerbated with the availability of multiple CSPs that may offer a variety of different services and models.

In contrast to conventional cloud hosted application placement services, disclosed herein are apparatuses and methods for selecting a cloud service provider (CSP) to host an application in which the selected CSP may already host a cloud application that matches the application. That is, the apparatuses disclosed herein may compare the details of the application with the details of cloud applications hosted by a plurality of CSPs to identify those CSPs that host applications that may be similar to the application. The apparatuses may also determine various features of the CSPs and based on the determined features of the CSPs, the apparatuses may select one of the CSPs to host the application. The details of the application and the details of the cloud applications hosted by the CSPs that may be compared may include but are not limited to performance requirements which may include compute, network and storage, high availability requirements, clustering stack, network requirements, virtualization, storage distribution, load balancing, application environments, monitoring and management, and the like.

The apparatuses may use various parameters to select a CSP to host an application and the parameters may be user-defined in some examples. In addition, different applications may have different parameters associated therewith and different parameters may be weighted differently from other parameters. When an application is being mapped to an external CSP for the external CSP to host the application, the parameters may be selected and mapped to particular features of the CSPs. The features of the CSPs may include information such as service type, service quality, cost of service, etc. The features regarding the CSPs may be received via Application Programming Interfaces (APIs) of feeds from the CSPs and a features database may be updated with the information regarding the CSPs so that the information remains up to date.

Additionally, weights that signify the importance of particular parameters for the application may also be considered when selecting the appropriate CSP. In some cases, a user may assign weights to the parameters. By way of illustration and not of limitation, a user may define that the cost of hosting the application is the most important consideration, uptime is next, security is the third most important consideration, etc. The weights thus provided may be applied to the parameters and the features and the results may be aggregated in order to obtain an aggregated weighted score for a CSP for the application. Similarly, aggregated weighted scores may be calculated for other CSPs and a CSP with the maximum aggregated weighted score may be selected to host the application.

In examples, an evaluation group including a plurality of entities may be mapped to one or more CSPs for the mapped CSPs to host the entities in the evaluation group. The entities in the evaluation group may include applications, servers, services, devices, combinations thereof, or the like. The evaluation group may contain homogenous entities in some examples. In some examples, the evaluation group may include non-homogenous entities. The parameters for the various entities may be selected using Artificial Intelligence (Al) elements such as but not limited to classifiers. The classifiers may be trained on training data that includes prior selections of parameters for the entities that occurred during successful entity mappings. The selected parameters of the entities may be mapped to the features of each of the CSPs to identify a CSP that is a best match for hosting the entities. Weights signifying the importance of the parameters may be applied to the features that are mapped to the parameters and the weighted features may be aggregated to obtain an aggregated weighted score for each CSP for a given entity. The aggregated weighted scores of the plurality of CSPs that are evaluated for the entity may be compared and a CSP with the highest aggregated weighted score is selected to host the entity. Similarly, the suitability of the plurality of CSPs to host the various entities in the evaluation group may be tested concurrently and the CSPs that best match the requirements of the entities may be selected to host the entities. In examples, the evaluation group may be mapped to a single CSP. The CSP to commonly host the plurality of entities of the evaluation group may be selected based on the number of entities that selected the CSP as the optimal host or the CSP that provided the best match for parameters having higher weights and the like.

The examples outlined above solve multiple problems in the areas of application hosting placement. Analysis and mapping of applications to cloud services may be a time-consuming task that requires a high level knowledge of application architecture. The apparatuses and methods disclosed herein may include a features database that stores features provided by the cloud platforms, which may provide a common source that enables concurrent suitability evaluation of multiple CSPs for an evaluation group regardless of whether the evaluation group includes a single application or multiple entities. The apparatuses and methods disclosed herein further may also enable evaluation of multiple cloud deployment models that increase application efficiency as it may be evaluated for migration to models other than conventional models like IaaS. With the cloud platform technology evolving at a fast pace, characteristics of the cloud service providers are also constantly updated which may cause prior application mappings to be rendered inefficient or ineffective. As the features database disclosed herein may be continuously updated, the apparatuses and methods described herein may enable constant availability of the most relevant and up to date data and features for mapping the applications, which may increase the efficiency of application mapping and migrating systems in an ever-changing cloud services provider landscape.

Before continuing, it is noted that as used herein, the terms “includes” and “including” mean, but are not limited to, “includes” or “including” and “includes at least” or “including at least.” The term “based on” means, but is not limited to, “based on” and “based at least in part on.”

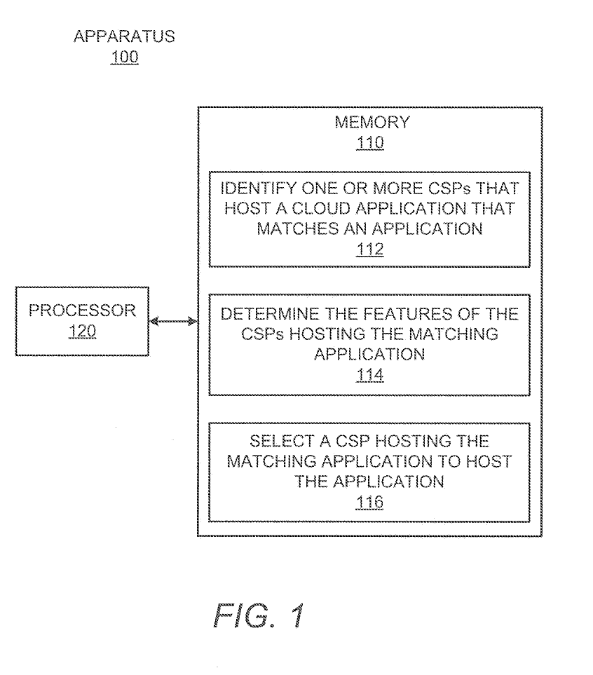

With reference first to FIG. 1, there is shown a block diagram of an example apparatus 100 that may determine a recommended cloud service provider (CSP) to host an application. It should be understood that the apparatus 100 depicted in FIG. 1 may include additional components and that some of the components described herein may be removed and/or modified without departing from a scope of the apparatus 100 disclosed herein.

The apparatus 100 may include a processor 120 that controls operations of the apparatus 100. The apparatus 100 may be a computing device such as a personal computer, a laptop computer, a smartphone, a server computer, a tablet computer, or the like. In a particular example, the apparatus 100 may be a cloud-based server. The processor 120 may be a semiconductor-based microprocessor, a central processing unit (CPU), an application specific integrated circuit (ASIC), a field-programmable gate array (FPGA), and/or other hardware device. Although a single processor 120 is depicted, it should be understood that the apparatus 100 may include multiple processors, multiple cores, or the like, without departing from a scope of the apparatus 100.

The apparatus 100 may also include a memory 110 that may have stored thereon machine readable instructions 112-116 (which may also be termed non-transitory computer readable instructions) that the processor 120 may execute. The memory 110 may be an electronic, magnetic, optical, or other physical storage device that contains or stores executable instructions. The memory 110 may be, for example, Random Access memory (RAM), an Electrically Erasable Programmable Read-Only Memory (EEPROM), a storage device, an optical disc, and the like. The memory 110, which may also be referred to as a computer readable storage medium, may be a non-transitory machine-readable storage medium, where the term “non-transitory” does not encompass transitory propagating signals.

The processor 120 may fetch, decode, and execute the instructions 112 to identify, based on a comparison of details of an application and details of cloud applications hosted on a plurality of CSPs, which of the plurality of CSPs hosts a cloud application that matches the application. The application to be hosted on the CSPs may include but is not limited to a web-based application, a stand-alone application or application suites, a utility, a database application, or the like. The CSPs that may be considered to host the application may include a public cloud-based hosting provider, a managed private cloud (MPC) provider, an information technology operations (ITO) provider, and the like. The different types of hosting providers may also include multiple public cloud-based hosting providers, multiple managed private clouds (MPCs), virtual or physical hosting compute platforms, or the like. The virtual or physical computing platforms may be of any operating system type on which the application may operate.

Various details of the application and the cloud applications may be tracked such as but not limited to, a type of application, a volume of users serviced by the application, certificate information of the application, the environment on which the application is to run, the types of data processed by the application, a desired backup size and backup retention length, a desired primary drive size and a desired database data size for the application, security requirements for the application, regulatory or compliance elements of the application, the external data sources if any that are accessed by the application, or the like. The type of data may include, for instance, whether the data is financial data, a trade secret, personally identifiable data, or the like. The environment in which the application is to be used may include, for instance, whether the application is to be used in a production environment or a development environment. The type of software platform may include, for instance, whether the software platform is a standard software platform or a specialized software platform.

The processor 120 may fetch, decode, and execute the instructions 114 to determine features of the CSPs that are identified as hosting applications that match the application to be hosted. According to examples, the features of the CSPs may be obtained from Application Programming Interfaces (APIs) that the CSPs may supply. A features database may store the features from the APIs of the CSPs or the features may also be manually input to the features database. The features of the CSPs may include the various cloud applications that the CSPs host, the service options of the CSPs including whether the CSPs offer one or more of the Infrastructure as a Service (IaaS), Software as a Service (SaaS) or Platform as a Service (PaaS), the costs associated with the various service options, the terms of the service options, security capabilities of the CSPs, redundancy of data storage available, etc.

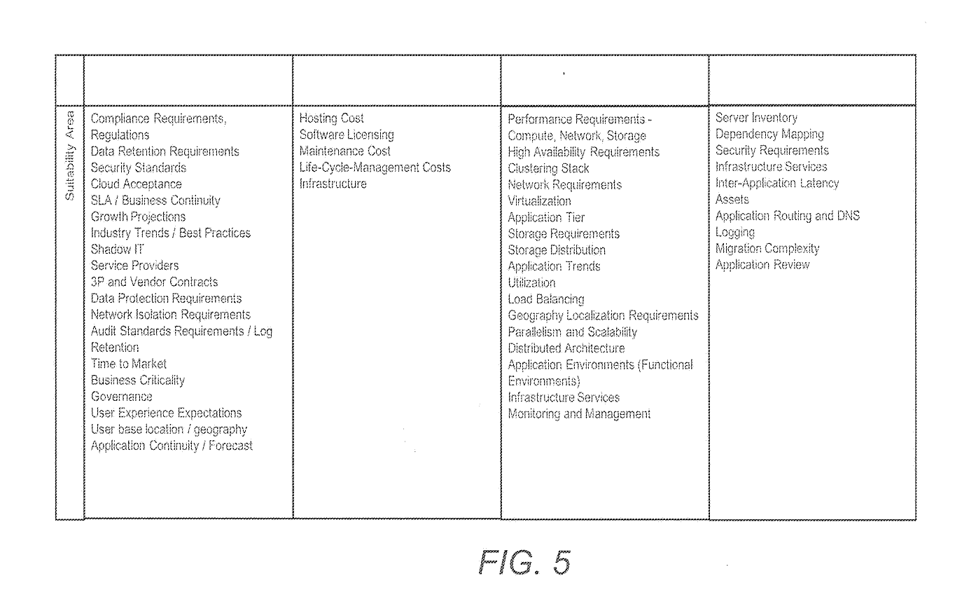

The processor 120 may fetch, decode, and execute the instructions 116 to select a CSP to host the application. The processor 120 may select the CSP to host the application from a subset of CSPs that are identified above via execution of the instructions 112 as hosting a cloud application that matches the application. In executing the instructions 116, the processor 120 may access predefined parameters for hosting the application and the processor 120 may select the CSP that has features that best match the predefined parameters as the selected cloud service to host the application. The predefined parameters may include, for instance, parameters that a CSP is to meet in order to host the application. The parameters may include, for instance, application availability requirements, backup for application data requirements, security requirements, service level agreement meeting requirements, virtualization requirements, or the like. Additional parameters are depicted in FIG. 5, which is discussed in greater detail herein.

According to examples, the predefined parameters that the processor 120 may consider in selecting the CSP to host the application may be user-defined. In addition, the user may assign weights to the predefined parameters such that some of the parameters may have a higher importance level than other ones of the parameters. That is, a user may assign a first weight to a first parameter, such as availability, and may assign a second weight to a second parameter, such as security, in which the first weight is higher than the second weight. In order to determine the CSP that has features that best match the predefined parameters, the processor 120 may implement a pattern matching operation on the predefined parameters and the features of the CSPs as detailed herein.

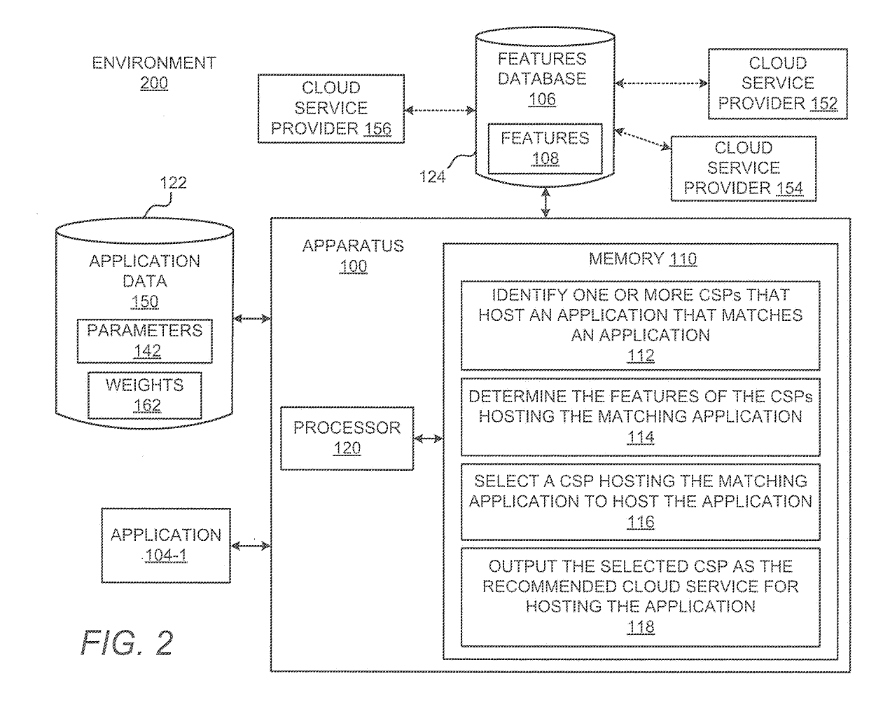

With reference to FIG. 2, there is shown a block diagram of an example environment 200 including an apparatus 100 that may select a CSP to host an application. The apparatus 100 may be communicatively coupled to local or external data storage 122 where information regarding an application 104-1 may be stored as application data 150. The application data 150 may include the parameters 142 outlined above and weights 162 that may be assigned to the parameters 142. The weights 162 may be predefined in the application data 150 and/or the weights 162 may be dynamically provided by a user.

The apparatus 100 may also be coupled to a data store 124 on which is stored a features database 106 that may store features 108 of a plurality of CSPs 152-156. It should be understood that three CSPs 152-156 are depicted for purposes of illustration and not of limitation and thus, the environment 200 may include any number of CSPs without departing from a scope of the environment 200 disclosed herein. Each of the CSPs 152-156 may transmit feature information regarding the services offered by the CSPs 152-156 via, for instance, Application Programming Interfaces (APIs). The features database 106 may store information received from the CSPs 152-156 as the features 108 of the CSPs 152-156. The features database 106 may be populated via manual and/or automated processes such that the features database 106 may be updated using API feeds from the CSPs 152-156. The features database 106 may be a NoSQL (No Structured Query Language) database that stores data received in various formats including relational and non-relational formats. Although configured to store data other than the tabular formats of relational data, the features database 106 may nevertheless support SQL-like query languages. The features 108 obtained via the APIs of the multiple CSPs 152-156 may include but are not limited to, service type, service quality, cost of service, or the like, as discussed above. In examples, the details regarding the CSPs 152-156 may be stored as Java Script Object Notation (JSON) files. Accordingly, the processor 120 may identify from the features 108 stored in the features database 106, a subset of the CSPs 152-156 that host a cloud application that matches the application 104-1. As discussed herein, the processor 120 may execute the instructions 114 to access the features database 106 to determine the features 108 of the subset of the CSPs 152-156 that host a cloud application that is similar to the application 104-1.

In addition to executing the instructions 112-114 as discussed above with respect to FIG. 1, the processor 120 may fetch, decode, and execute the instructions 116 to output the selected CSP from the subset of the CSPs that host the similar cloud application to host the application 104-1. According to examples, the processor 120 may match the application 104-1 to a CSP 152-156 and a service provided therewithin based on a maximum number of feature equivalences derived from a matching process. The details of the matching process will be discussed further infra. The apparatus 100 may further receive user priorities on the parameters 142 that may be employed as weights 162 in the matching process in order to enable an optimal selection of the CSP 152 to host the application 104-1.

On identifying the CSP 152 to host the application 104-1, the processor 120 may execute the instructions 118 to output the selected CSP as the recommended cloud service provider to host the application 104-1. The processor 120 may include specific details regarding the migration of the application 104-1 to the CSP 152 identified as the recommended cloud service provider. For example, the processor 120 may recommend the selection of a public cloud service, a private cloud service or a hybrid service to host the application 104-1. The processor 120 may enable automated mapping of the application 104-1 to cloud service provider targets, which may decrease the time required to map applications to those services that the CSPs 152-156 provide. This approach may allow mapping to the cloud service providers 152-156 for applications to be performed in bulk thereby reducing monotonous and time-consuming application analysis efforts. That is, for instance, the processor 120 may execute the instructions 118 to cause the application 104-1 to be migrated to the selected CSP 152.

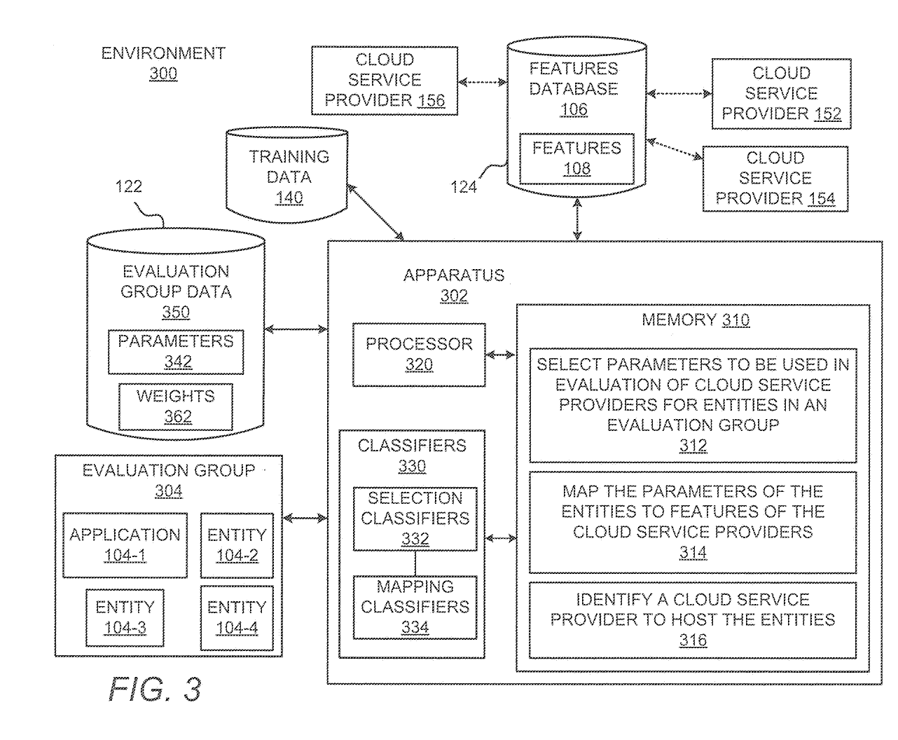

With reference to FIG. 3, there is shown a block diagram of an example environment 300 including an apparatus 302 that may determine one or more of the CSPs 152-156 to host an evaluation group 304 that may include a plurality of entities 104-1, 104-2, 104-3, and 104-1. It should be understood that the environment 300 depicted in FIG. 3 may include additional components and that some of the components described herein may be removed and/or modified without departing from a scope of the environment 300 disclosed herein.

As shown, the environment 300 may include a processor 320 and a memory 310, which may respectively be similar to the processor 120 and the memory 110 included in the apparatus 100. As such, like reference numerals are used in FIG. 3 for like elements. In the environment 300 depicted in FIG. 3, the application 104-1 may be included in the evaluation group 304 that includes other entities 104-2 to 104-4. The evaluation group 304 may be associated with a section of an organization such as a department, a physical location, a part of the physical location or other geographical, technical or logical unstructured grouping of the information technology (IT) resources represented by the plurality of entities 104-2 to 104-4, etc. Of course, it can be understood that only four entities are shown for brevity and that the evaluation group 304 may include any number of entities 104-1 to 104-4. The entities 104-1 to 104-4 may include homogenous entities such that the entities 104-1 to 104-4 may be different applications in one example. In other examples, the entities 104-1 to 104-4 may be non-homogenous entities such that the evaluation group 304 may include, for instance, servers, applications, services, devices, people, processes, combinations thereof, or the like.

The processor 320 may fetch, decode, and execute the instructions 312 to select parameters 342 for each of the entities 104-1 to 104-4 that are to be used in evaluation of a plurality of cloud service providers 152-156 for identifying one or more of the CSPs 152-156 to host the entities 104-1 to 104-4. Information regarding the evaluation group 304 and the entities 104-1 to 104-4 such as the parameters 342 may be stored as a part of the evaluation group data 350 on a local or external data storage 122. For example, the information regarding an entity, in which the entity is an application, may include but is not limited to, load balancer, location, certificate, version, number of users, or the like. Similarly, information regarding an entity, in which the entity is a device, may include a unique device id, the software installed on the device, the hardware components of the device, a geographic location of the device, or the like. Information regarding an entity, in which the entity is a server, may include a geographic location of the server, an internet protocol (IP) address of the server, the software installed in the server such as the operating system (OS), applications, databases, or the like. In addition, information regarding the evaluation group 304 may include inter-related information regarding the various entities 104-1 to 104-4 or the like. For example, if one of the entities is a server hosting an application, such inter-relationships between the entities may be recorded in the evaluation group data 350. It can be appreciated that as the application 104-1 forms a part of the evaluation group 304, the parameters 142 of the application 104-1 may be a subset of the parameters 342 in the evaluation group data 350.

The apparatus 302 may further include trained classifiers 330 that the processor 320 may employ for various processes in the identification of the one or more CSPs 152-156 to host the entities 104-1 to 104-4. In particular, the classifiers 330 may include selection classifiers 332, which may be trained to select particular parameters for each of the entities 104-1 to 104-4 to identify one of the CSPs 152-156 to host that entity 104-1 to 104-4. In examples, data collected from prior successful mappings of various entities to CSPs 152-156 may be collected and used as training data 140 to train the classifiers 330. The training data 140 may include data regarding selection of parameters for various entities 104-1 to 104-4 in the evaluation group 304 for training the selection classifiers 332. Based on a type of entity such as whether the entity to be mapped is a server entity, a device entity, an employee entity, a user entity or an application entity, a subset of the parameters 342 may be selected from the evaluation group data 350 to identify matching features 108 from the features database 106 for that particular entity. Similarly, subsets of parameters 342 that are selected by the selection classifiers 332 for the entities 104-1 to 104-4 within the evaluation group 304 may form a complete set of parameters 342 associated with the evaluation group 304. The training data 140 may also include data regarding mappings of the parameters 342 to the features 108 of the CSPs 152-156 used in the successful migrations of the entities 104-1 to 104-4 to the CSPs 152-156. The training data regarding the mappings may be used to train the mapping classifiers 334.

According to examples, the processor 320 may fetch, decode, and execute the instructions 314 to map the parameters 342 of the entities 104-1 to 104-4 to features 108 of the CSPs 152-156. For instance, the processor 320 may use the mapping classifiers 334 to automatically map the parameters 342 to the features 108 of the CSPs 152-154. In examples, the mapping classifiers 334 may employ the mapping classifiers 334 to map the parameters 342 to the features 108. Based on the mappings and the weights 362 associated with the various parameters 342, aggregated weighted scores may be obtained for each of the CSPs 152-156.

The processor 320 may also fetch, decode, and execute the instructions 316 to identify one or more of the CSPs 152-156 to host each of the entities 104-1 to 104-4. In examples, the entities 104-1 to 104-4 may be mapped to the same CSP 152 or to multiple CSPs 152-156. That is, for instance, a first entity 104-1 may be mapped to a first CSP 152 and a second entity 104-2 may be mapped to a second CSP 154. In addition, the processor 120 may cause the entities 104-1 to 104-4 to be migrated to the selected CSP 152 or CSPs 152-156. By way of example, the processor 320 may communicate an instruction for the entities 104-1 to 104-4 to be migrated from their current locations to the selected CSP 152 or CSPs 152-156. In this regard, the processor 320 may automatically cause the entities 104-1 to 104-4 to be migrated, e.g., without user intervention.

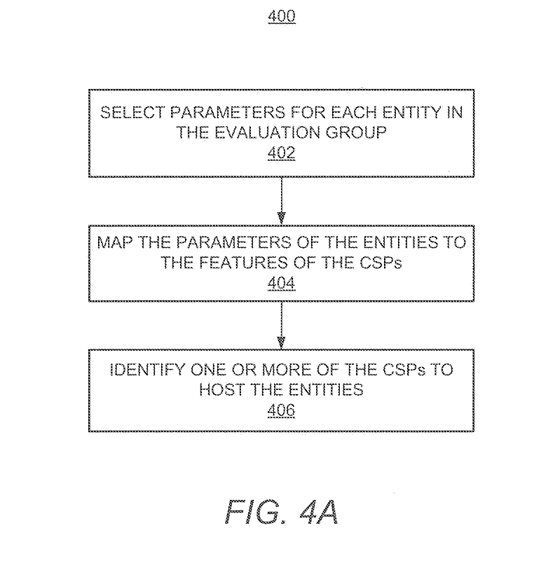

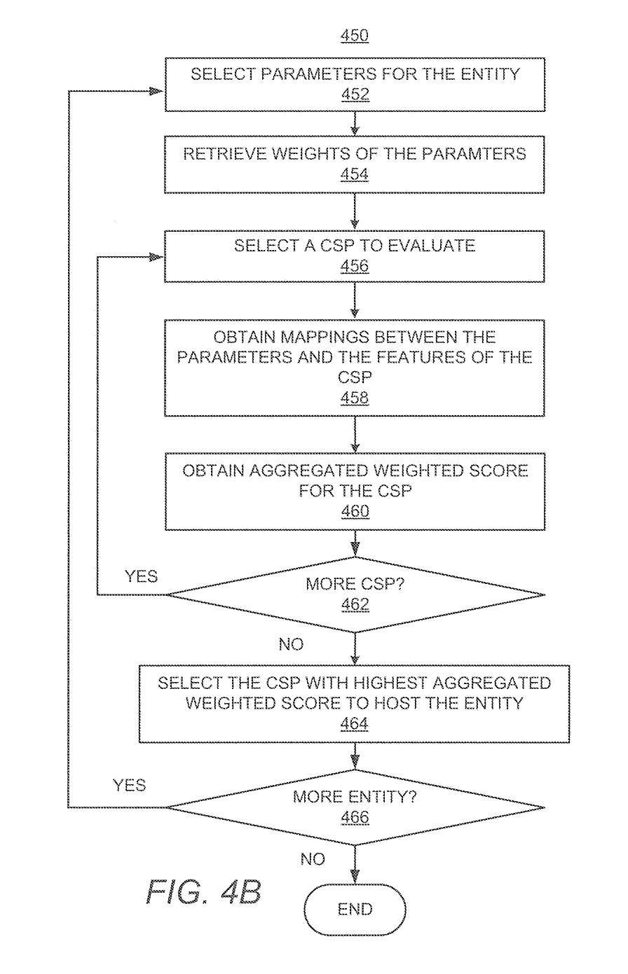

Various manners in which the apparatus 302 may be implemented are discussed in greater detail with respect to the methods 350 and 400 respectively depicted in FIGS. 4A and 4B. Particularly, FIGS. 4A and 4B, respectively, depict flow diagrams of example methods 400 and 450 for identifying one or more cloud service providers to host entities of an evaluation group. It should be understood that the methods 400 and 450 depicted in FIGS. 4A and 4 may include additional operations and that some of the operations described therein may be removed and/or modified without departing from the scopes of the methods 400 and 450. The descriptions of the methods 400 and 450 are made with reference to the features depicted in FIG. 3 for purposes of illustration.

With reference to FIG. 4A, at block 402, the processor 320 may select parameters to be used in evaluation of a plurality of cloud service providers 152-156 for each entity of a plurality of entities 104-1 to 104-4 in an evaluation group 304. At block 404, the processor 320 may map the selected parameters 342 of the entities 104-1 to 104-4 to the features 108 of the CSPs 152-156. The processor 320 may perform the mapping such that the mapping not only compares compute and performance features but also compares various other features such as application characteristics to be found in the CSPs 152-156 which may lead to selection of at least one relevant and optimal target cloud service provider 152-156 for the entities 104-1 to 104-4. The mapping procedure may include one-to-one mappings between the parameters 342 and the features 108 or the processor 320 may map multiple features 108 to one parameter 342 or vice versa. At block 406, the processor 320 may, based on the mapping of the parameter 342 to the features 108 of the plurality of cloud service providers 152-156, identify one or more of the CSPs 152-156 to host the entities 104-1 to 104-4 in the evaluation group 304. Following block 406, the processor 320 may cause the entities 104-1 to 104-4 to be migrated as discussed herein.

With reference now to FIG. 4B, it is to be appreciated that the method 450 shows serial processing of the entities 104-1 to 104-4 for illustration purposes only. Instead, the processor 320 may simultaneously identify, via parallel processing, CSPs from the plurality of CSPs 152-156 for the entities 104-1 to 104-4 thereby concurrently handling mapping for a large number of entities 104-1 to 104-4, which may occur in data center migration tasks.

At block 452, the processor 320 may select a subset of the parameters 342 stored in the evaluation group data 350 to be used in the evaluation of a particular entity 104-1. As discussed above, the processor 320 may employ the selection classifiers 332 to select the subset of parameters 342 for the entity 104-1. At block 454, the processor 320 may retrieve weights 362 assigned to the selected subset of parameters 342. The retrieved weights 362 for the subset of parameters 342 may signify an importance associated with each of the parameters in the selected subset. The weights 362 may be set by default in the evaluation group data 350 or a user may manually set the weights 362.

At block 456, the processor 320 select one of the CSPs 152-156 for evaluation. In addition, at block 458, the processor 320 may obtain mappings between the weighted parameters 342 to be used in the evaluation of the entity 104-1 and features 108 of the CSP 152 that is currently being evaluated. As mentioned above, the processor 320 may use the mapping classifiers 334 for the mappings between the entity 104-1 and the CSP 152.

At block 460, the processor 320 may obtain an aggregated weighted score of the CSP 152 selected at block 456 for that particular entity 104-1 for which the parameter subset was selected at block 452. The processor 320 may execute instructions as outlined at blocks 456-460 if the processor 320 detects at block 462 that more CSPs remain to be evaluated. If the processor 320 determines at block 462 that each of the CSPs 152-156 are evaluated, the processor 320 may compare the aggregated weighted scores and may determine the CSP 152 with the highest aggregated weighted score to be the best match for the entity 104-1. The processor 320 may also select that determined CSP 152 at block 464 to host the entity 104-1. The processor 320 may also determine, at block 466, as to whether a further entity 104-2 from the evaluation group 304 has not been mapped. In response to a determination that the further entity 104-2 has not been mapped, the processor 320 may repeat blocks 452-466 to mapping the further entity 104-2 to one of the CSPs 152-156. In addition, blocks 452-456 may be repeated for any remaining entities 104-3 and 104-3 in the evaluation group 304 to map those entities 104-3 and 104-4 to one of the CSPs 152-156. Following a placement determination for each of the entities 104-1 to 104-4 in the evaluation group 304, the processor 320 may cause the entities 104-1 to 104-4 to be migrated to the selected CSP or CSPs 152-156 as discussed herein.

In some examples, through implementation of the method 450, the processor 320 may select the same CSP 152 to host all of the entities 104-1 to 104-4 in the evaluation group 304. In these examples, the processor 320 may select the CSP 152-156 to which a majority of the entities 104-1 to 104-4 are mapped to host the entities 104-1 to 104-4. In other examples, the processor 320 may select multiple ones of the CSPs 152-156 to host the entities 104-1 to 104-4 such that a first one of the CSPs 152 may host a first one of the entitles 104-1 and a second one of the CSPs 154 may host a second one of the entities 104-2.

Some or all of the operations set forth in the methods 400 and 450 may be contained as utilities, programs, or subprograms, in any desired computer accessible medium. In addition, the methods 400 and 450 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

FIG. 5 is a listing of the parameters 342 pertaining to the various entities 104-1 to 104-4 in the evaluation group 304 that may be included in the evaluation group data 350 to evaluate suitability of the CSPs 152-156 in hosting the entities 104-1 to 104-4. By employing some of the parameters as shown in FIG. 5, the apparatuses 100 and 300 may automate the CSP evaluation process while increasing the efficiency and accuracy of cloud host evaluation systems and procedures.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine readable instructions to cause the processor to:
identify, based on a comparison of details of an application and details of cloud applications hosted on a plurality of cloud service providers, which of the plurality of cloud service providers hosts a cloud application that matches the application;
determine, for the cloud service providers that host cloud applications that match the application, features associated with hosting the cloud applications; and
based on the determined features of the cloud service providers, select a cloud service provider of the cloud service providers that host cloud applications that match the application to host the application.

2. The apparatus of claim 1, wherein the instructions are further to cause the processor to:
access predefined parameters for hosting the application;
determine which of the cloud service providers has features that best match the predefined parameters; and
select the cloud service provider having features that best match the predefined parameters as the selected cloud service to host the application.

3. The apparatus of claim 2, wherein the predefined parameters comprise a plurality of weighted parameters associated with hosting the application, each of the weights signifying an importance associated with the parameter, and wherein to determine which of the cloud service providers has features that best match the predefined parameters, the instructions are further to cause the processor to perform a pattern matching operation on the predefined parameters and the features of the cloud service providers.

4. The apparatus of claim 1, wherein the instructions are further to cause the processor to access a database having stored thereon the features of the cloud service providers, and wherein the features of the cloud service providers include at least one of service type, service quality, or cost of service.

5. The apparatus of claim 1, wherein to identify which of the plurality of cloud service providers that host cloud applications that match the application and to determine the features associated with hosting the cloud applications, the instructions are further to cause the processor to access a database on which is stored information pertaining to the details of the cloud applications and the features of the cloud service providers.

6. The apparatus of claim 1, wherein the application is an entity in an evaluation group of entities, and wherein the instructions are further to cause the processor to:
determine cloud service providers that host cloud applications having details similar to details of the entities in the evaluation group;
determine features of the determined cloud service providers; and
based on the determined features of the determined cloud service providers, select at least one of the determined cloud service providers to host the entities in the evaluation group.

7. The apparatus of claim 6, wherein the instructions are further to cause the processor to access a database having stored thereon the features of the cloud service providers, and wherein the features of the cloud service providers include at least one of service type, service quality, or cost of service.

8. The apparatus of claim 6, wherein the instructions are further to cause the processor to:
access predefined parameters for hosting the entities;
determine which of the cloud service providers has features that best match the predefined parameters; and
select the cloud service provider having features that best match the predefined parameters as the selected cloud service to host the entities in the evaluation group.

9. The apparatus of claim 1, wherein the details of the application include at least one of a type of the application, a function of the application, a number of instances of the application, a location of the application, or a certificate of the application.

10. The apparatus of claim 1, wherein the cloud service providers include at least one of a private cloud services provider, a hybrid cloud services provider, or a public cloud services provider.

11. A method comprising:
selecting, by a processor, parameters to be used in evaluation of a plurality of cloud service providers for each entity of a plurality of entities in an evaluation group;
mapping, by the processor, the selected parameters of the plurality of entities to features of the plurality of cloud service providers; and
based on the mapping of the parameters of the plurality of entities to the features of the plurality of cloud service providers, identifying, by the processor, a cloud service provider of the plurality of cloud service providers to host the plurality of entities in the evaluation group.

12. The method of claim 11, wherein mapping the parameters of the entities to the features of the cloud service providers further comprises:
retrieving weights associated with the parameters of the entities;
weighing each of the features mapped to one or more of the parameters with respective parameter weights; and
obtaining an aggregated weighted score for the cloud service provider by combining the weighted features.

13. The method of claim 12, wherein identifying the cloud service provider to host the plurality of entities further comprises:
identifying the cloud service provider to host the plurality of entities as the cloud service provider of the plurality of cloud service providers having the highest aggregated weighted score.

14. The method of claim 11, further comprising:
receiving information regarding the features of the cloud service providers using APIs of feeds from the cloud service providers; and
storing the received information in a features database.

15. The method of claim 11, wherein identifying a cloud service provider to host the entities further comprises:
accessing training data including prior selections of the parameters;
training selection classifiers on the accessed training data for the selection of the parameters for each of the entities; and
training mapping classifiers on the training data for mapping the parameters of the entities to the features of the cloud service providers.

16. The method of claim 11, wherein the entities in the evaluation group are non-homogenous entities including any of applications, servers, services, or devices.

17. The method of claim 11, wherein the plurality of cloud service providers include at least one of a private cloud services provider, a hybrid cloud services provider, or a public cloud services provider.

18. A non-transitory computer readable medium on which are stored machine readable instructions that when executed by a processor, cause the processor to:
identify, based on a comparison of details of an application and details of cloud applications hosted on a plurality of cloud service providers, which of the plurality of cloud service providers hosts a cloud application that matches the application;
determine, for the cloud service providers that host cloud applications that match the application, features associated with hosting the cloud applications; and
based on the determined features of the cloud service providers, select a cloud service provider of the cloud service providers that host cloud applications that match the application to host the application.

19. The non-transitory computer readable medium according to claim 18, wherein the instructions to select a cloud service provider are further to cause the processor to:
access predefined parameters for hosting the application;
determine which of the cloud service providers has features that best match the predefined parameters; and
select the cloud service provider having features that best match the predefined parameters as the selected cloud service to host the application.

20. The non-transitory computer readable medium according to claim 18, wherein the application is an entity in an evaluation group of entities, and wherein the instructions are further to cause the processor to:
determine cloud service providers that host cloud applications having details similar to details of the entities in the evaluation group;
determine features of the determined cloud service providers; and
based on the determined features of the determined cloud service providers, select at least one of the determined cloud service providers to host the entities in the evaluation group.
